(19) United States
(12) Patent Application Publication
(10) Pub. No.: US 2020/0151583 A1
(43) Pub. Date: May 14, 2020

(54) ATTENTIVE DIALOGUE CUSTOMER SERVICE SYSTEM AND METHOD

(71) Applicant: Capital One Services, LLC, McLean, VA (US)

(72) Inventors: Erik T. MUELLER, Chevy Chase, MD (US); Alexandra COMAN, McLean, VA (US)

(73) Assignee: Capital One Services, LLC, McLean, VA (US)

(21) Appl. No.: 16/673,944

(22) Filed: Nov. 4, 2019

Related U.S. Application Data
(60) Provisional application No. 62/760,639, filed on Nov. 13, 2018.

(51) Int. Cl. G06N 5/02; G06F 17/27; G06Q 30/00

(52) U.S. Cl. CPC G06N 5/02; G06Q 30/016; G06F 17/2785

(57) ABSTRACT

A method, system, and article. A non-transitory computer-readable storage medium may include computer-readable program code executable by a processor to: determine a set of customer concerns by a set of AI engines executing on the processor, the set of customer concerns based upon customer input from a customer, the customer input being received by one of: an interactive voice response system, a phone system, a short message service system, an email message, and a data network. The computer-readable program code may be executable to generate an acknowledgment of the set of customer concerns, by the AI engines executing on the processor; and perform a problem-solving cycle, based upon the set of customer concerns. The performing of the problem-solving cycle may include adapting a solution to an obstacle identified in the set of customer concerns; suggesting an alternative solution to the customer; and narrating a set of actions taken during the problem-solving cycle.

### RELATED APPLICATION

This application is a continuation of U.S. Provisional Patent Application Ser. No. 62/760,639, titled “Attentive Dialogue Customer Service System and Method” filed on Nov. 13, 2018. The contents of the aforementioned application is incorporated herein by reference in its entirety.

### TECHNICAL FIELD

Embodiments herein generally relate to automated customer services, and more specifically, to interactive customer service systems.

### BACKGROUND

Automated customer service is provided over a myriad of businesses, including telephone-based systems, web-based systems, and other systems. In a customer service context, achieving rapport and authenticity may be useful, but challenging, even when customer service is provided by a human assistant. The same applies in an automated customer service scenario, where a computer-based system may employ a set of artificial intelligence (AI) agents to interact with the customer. While approaches that generate rapport and achieve authenticity are more likely to be positively received than affective empathy, such as hollow expressions of regret and commiseration, present day automated customer service systems fail to engage a customer in a manner that generates such rapport.

### BRIEF SUMMARY

In one embodiment, a non-transitory computer-readable storage medium is provided for storing computer-readable program code executable by a processor to determine a set of customer concerns by a set of AI engines executing on the processor. The set of customer concerns may be based upon customer input from a customer, where the customer input is being received by one of: an interactive voice response system, a phone system, a short message service system, an email message, and a data network. The program code may generate an acknowledgment of the set of customer concerns, by the AI engines executing on the processor, and perform a problem-solving cycle, by the AI engines executing on the processor, based upon the set of customer concerns. Performing the problem-solving cycle may include adapting a solution to an obstacle identified in the set of customer concerns, suggesting an alternative solution to the customer, and narrating a set of actions taken during the problem-solving cycle.

In another embodiment, a method may include determining, by a set of AI engines executing on a processor, a set of customer concerns based upon customer input, received from a customer. The customer input may be received by one of: an interactive voice response system, a phone system, a short message service system, an email message, and a data network. The method may include acknowledging, by the set of AI engines executing on the processor, the set of customer concerns; and performing, by the set of AI engines executing on the processor, a problem-solving cycle, based upon the set of customer concerns. The performing of the problem-solving cycle may further include adapting a solution to an obstacle identified in the set of customer concerns, suggesting an alternative solution to the customer, and narrating a set of actions taken during the problem-solving cycle.

In a further embodiment, a system may include a processor as well as an interface, to receive customer input, coupled to the processor. The interface may include one of: an interactive voice response system, a phone system, a short message service system, an email message system; and a data network. The system may include a memory storing instructions executable by the processor to determine a set of customer concerns by a set of AI engines, the set of customer concerns based upon customer input from a customer, received over the interface; to generate an acknowledgment by the set of AI engines, of the set of customer concerns; and to perform a problem-solving cycle by the set of AI engines, based upon the set of customer concerns. The performing of the problem-solving cycle may include adapting a solution to an obstacle identified in the set of customer concerns; suggesting an alternative solution to the customer; and narrating a set of actions taken during the problem-solving cycle.

### BRIEF DESCRIPTION OF THE DRAWINGS

FIG. 1 illustrates an embodiment of a system.

FIG. 2 and FIG. 3 illustrate embodiments of an attentive dialogue generated in part by the system of FIG. 1.

FIG. 4 depicts the arrangement of an attentive dialogue agent for one implementation of attentive dialogue.

FIG. 5 depicts details of the implementation of FIG. 4.

FIG. 6 illustrates an embodiment of a first logic flow.

FIG. 7 illustrates an embodiment of a second logic flow.

FIG. 8 illustrates an embodiment of a computing architecture.

### DETAILED DESCRIPTION

Embodiments disclosed herein provide a digital platform employing artificial intelligence agents for engaging in a natural language customer service dialogue with a customer. Examples of a customer include a customer or a potential customer of a commercial institution, such as a financial institution; a shopper or potential shopper of a commercial institution; a user or requestor of information for any institution, non-commercial, governmental, commercial, or private institution. The term “customer” may be used herein to refer to a user, requestor, or customer in any such activity, or similar activity.

In various embodiments a system is provided for performing a plurality of operations including at least two of: addressing explicitly stated customer needs and intentions, inferring customer needs and intentions not explicitly stated by the customer, verifying correctness of information stated by the customer, correcting misconceptions of the customer, paraphrasing and summarizing customer statements, elaborating upon customer statements, adjusting language to conform to the customer's language, using tactful language expressions, helping the customer by suggesting language, providing information about the problem-solving activity of the agent, providing explanations as to why the agent is asking something, providing explanations for what the agent is doing, performing tactfulness assessment on all utterances to ensure that they maintain a positive customer experience, assessing the potential consequences of all utterances, brainstorming diverse solutions with the customer, expressing cognitive and attentive empathy, acknowledging personal information provided by the customer, providing solutions to the customer, retrieving information for the customer, and/or executing transactions on behalf of the customer.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

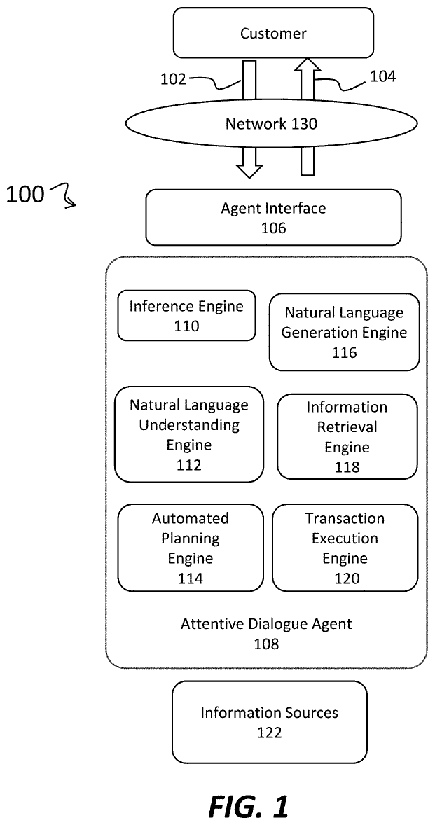

FIG. 1 depicts a schematic of an exemplary system, labeled system 100, consistent with disclosed embodiments. The system 100 may represent an artificial intelligence system (AI system) to be deployed in various contexts, such as in a commercial institution, a financial institution, a business, a services provider, a governmental institution, a non-profit institution, a private institution. The embodiments are not limited in this context.

The system 100 may comprise an agent interface 106, interacting with a customer over a network 130. The network 130 or at least part of the network 130 may be embodied as a communication system including an interactive voice response system, a phone system, a short message service system, an email messaging system, and a data network. As such, the network 130 may embody a plurality of systems, including any combination of the aforementioned communication systems. Moreover, the agent interface 106, or a portion of the agent interface may be embodied within the network 130. According to various embodiments, the agent interface 106 may be a voice interface and/or a chatbot interface. A voice interface is configured to generate audible speech such that an attentive dialogue agent 108 may engage in conversations with another party. The agent interface 106 may further convert received speech to text (e.g., based on a known language processing algorithm (not separately shown) to facilitate the ability of the system 100 to engage in attentive dialogue. As such, the system 100 may be configured to operate without human participation within system 100, while engaging human input from the customer, received over the network 130.

In various embodiments, the customer may interact with the system 100 via the network 130 using any appropriate device, including a telephone, smartphone, computer, laptop, tablet, phablet, smartphone, smartwatch, or similar mobile computing device, keyboard interface, keypad interface, touchscreen interface, voice-activated system, and so forth. The embodiments are not limited in this context.

Thus, when a user initiates a communication or query 102, the query 102 may be transmitted through a variety of different channels in different embodiments, including voice, text, and so forth, before being received by the system 100. Likewise, the system 100 may generate a response 104, or series of responses to be transmitted over a variety of different channels according to different embodiments of the disclosure. As such, the components of the agent interface 106 may vary according to different embodiments as will be appreciated by one of skill in the art.

As shown, the system 100 includes an attentive dialogue agent 108, where the attentive dialogue agent 108 may include a multiplicity of artificial components, including artificial intelligence engines. These engines may be embodied in one or more host computers or servers, collocated, or coupled to one another by one or more networks. In the embodiment of FIG. 1, the attentive dialogue agent includes an inference engine 110, natural language understanding engine 112, automated planning engine 114, natural language generation engine 116, information retrieval engine 118, and transaction execution engine 120. The system 100 also includes a set of information sources, shown as information sources 122, arranged in storage media, such as known non-volatile storage media, dispersed in different locations, or collocated in a common location. Examples of information or data stored in information sources 122 include customer information related to the customer engaging the system 100. The customer information may include customer account information, biographical information, prior customer history, and so forth. The information sources 122 may further include services provided by an institution associated with the system 100, products provided by the institution, catalogues, business rules, and so forth.

As detailed below, the engines of attentive dialogue agent 108 are arranged to dynamically engage a user or customer in real time to provide an attentive dialogue, in a natural language setting, where the attentive dialogue agent 108 may be sufficiently engaged with the customer to arrive at a solution to one or more customer concerns, even when the concerns or issues may be ill-defined at the outset.

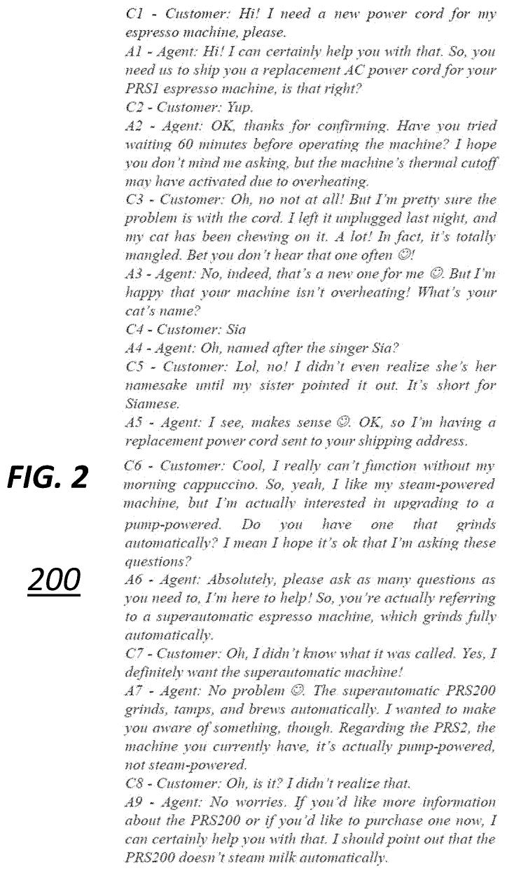

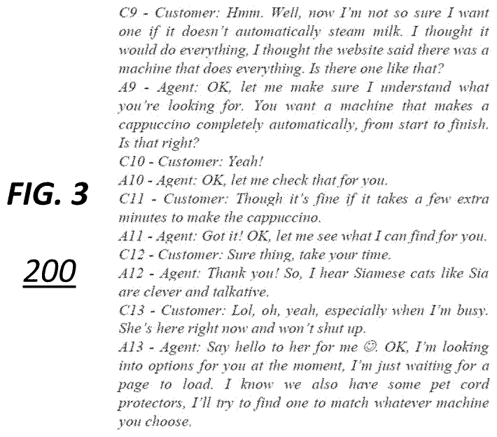

FIG. 2 and FIG. 3 illustrate an embodiment of an attentive dialogue 200 generated by the system 100 and a customer interacting with the system 100. The attentive dialogue 200, shown as text, may be embodied in different combinations of customer input and system response. For example, the customer input may be received as natural language text, while the system response is machine generated natural language audible dialogue; both customer input and system response may be natural language audible dialogue, and so forth.

Generally, the attentive dialogue 200 reflects a customer interaction wherein the customer may offer initial information and a request, leading to a series of interactions to define a customer concern and generate a customer solution for the customer. In the attentive dialogue 200, the customer expresses an initial statement, a request for a new power cord for an espresso machine. After engaging in a series of questions to establish that indeed the customer does need a new cord, the agent indicates that a new cord will be shipped (A1-A5). Rapport having been established, the customer further indicates a desire to upgrade their espresso machine (C6), which triggers further dialogue (A7-A13), to establish that the customer wants a machine capable of cappuccino-making.

Following the attentive dialogue 200, the agent may suggest three espresso machines that take into account the customer's expressed and implied preferences, and the customer may select and purchase one of the suggested machines.

To implement attentive dialogue interactions, such as the attentive dialogue 200, in an AI agent system of the disclosed embodiments, the attentive dialogue agent 108 employs the various engines to implement procedures including verification, paraphrasing/summarization/elaboration, language assistance, and transparent cognition, among others. According to various embodiments, the attentive dialogue agent 108 may determine a set of customer concerns, based upon customer input from a customer, and acknowledge the set of customer concerns to the customer. In a given customer interaction, the attentive dialogue agent 108 may then engage in a problem-solving cycle, based upon the set of customer concerns. As shown in the example of the attentive dialogue 200, and discussed in more detail below, the problem-solving cycle may involve different activities beyond mere acknowledgement of an initial concern, and providing a solution to the initial concern. For example, the problem-solving cycle may include adapting a solution to an obstacle identified in the set of customer concerns, suggesting an alternative solution to the customer, and/or narrating a set of actions taken during the problem-solving cycle. In this manner, a more useful solution may be provided and conveyed to the customer in a manner rendering the customer more satisfied with the interaction.

As part of the attentive dialogue, determining the customer concern may include a series of operations that start with receiving an initial concern. These operations may include clarifying the initial concern with the customer, verifying facts associated with the customer input, elaborating the initial concern with the customer, correcting a misconception with the customer, and/or suggesting language to the customer.

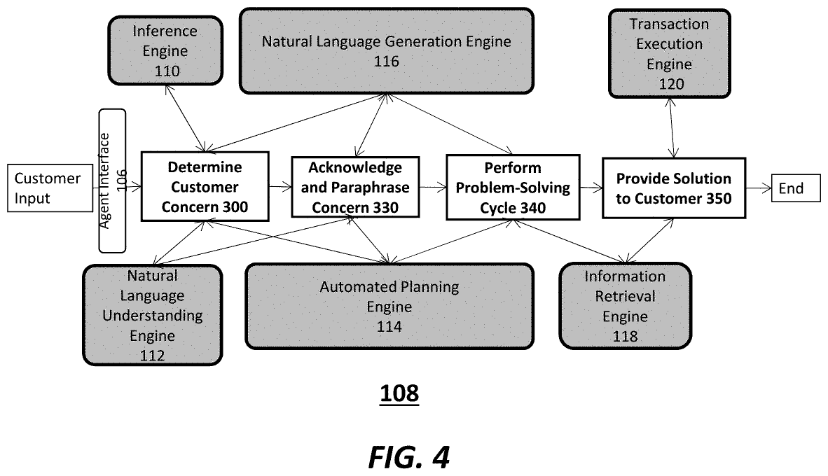

FIG. 4 illustrates an example scenario for implementing attentive dialogue, consistent with embodiments of the disclosure, where customer input is received by the attentive dialogue agent 108. The customer input is processed to determine customer concern at block 300, followed by acknowledging and paraphrasing the customer concern to the customer at block 330, performing a problem-solving cycle at block 340, and providing a solution to the customer at block 350. As shown in FIG. 4, the various AI engines of the attentive dialogue agent 108 may interoperate among one another to perform the operations shown. The natural language understanding engine 112 (NLU engine) may operate with the agent interface 106 to receive customer input and translate the customer input into machine-readable output. As an example, where voice input is received, the natural language understanding engine 112 may be configured to receive the voice input and interpret the voice input according to a selected language for interpretation. The natural language understanding engine 112 may operate with an automated voice recognition system as known in the art, to translate voice input into machine-readable input.

As discussed below, the inference engine 110, natural language understanding engine 112, and automated planning engine 114 may contribute to the operation of determining the customer concern.

Moreover, as illustrated in FIG. 4, the automated planning engine 114, natural language generation engine 116 (NLG engine), and natural language understanding engine 112 may operate to acknowledge and paraphrase the concern.

In some embodiments, the natural language understanding engine 112 may determine the meaning of an incoming dialogue input by utilizing one or more of the following artificial intelligence techniques: intent classification, named entity recognition (NER), sentiment analysis, relation extraction, semantic role labeling, question analysis, rule extraction and discovery, and story understanding. Intent classification may include mapping text, audio, video, or other media into an intent chosen from a set of intents, which represent what a customer is stating, requesting, commanding, asking, or promising, in for example an incoming customer input. Intent classifications may include, for example, a request for an account balance, a request to activate a credit/debit card, an indication of satisfaction, a request to transfer funds, or any other intent a customer may have in communicating an input. Named entity recognition may involve identifying named entities such as persons, places, organizations, account types, and product types in text, audio, video, or other media. Sentiment analysis may involve mapping text, audio, video, or other media into an emotion chosen from a set of emotions. For example, a set of emotions may include positive, negative, anger, anticipation, disgust, distrust, fear, happiness, joy, sadness, surprise, and/or trust. Relation extraction may involve identifying relations between one or more named entities in text, audio, video, or other media. A relation may be for example, a “customer of” relation that indicates that a person is a customer of an organization. Semantic role labeling may involve identifying predicates along with roles that participants play in text, audio, video, or other media. An example of semantic role labeling may be identifying (1) the predicate Eat, (2) Tim, who plays the role of Agent, and (3) orange, which plays the role of Patient, in the sentence “Tim ate the orange.” Question analysis may involve performing natural language analysis on a question, including syntactic parsing, intent classification, semantic role labeling, relation extraction, information extraction, classifying the type of question, and identifying what type of entity is being requested. Rule extraction and discovery may involve extracting general inference rules in text, audio, video, or other media. An example of rule extraction may be extracting the rule that “When a person turns on a light, the light will light up” from “Matt turned on the light, but it didn't light up.” Story understanding may involve taking a story and identifying story elements including (1) events, processes, and states, (2) goals, plans, intentions, needs, emotions, and moods of the speaker and characters in the story, (3) situations and scripts, and (4) themes, morals, and the point of the story.

According to some embodiments, the Natural Language generation engine 116 may perform natural language generation by utilizing one or more of the following artificial intelligence techniques: content determination, discourse structuring, referring expression generation, lexicalization, linguistic realization, explanation generation, end-to-end models, generative models, and deep learning. Content determination may involve deciding what content to present to the customer out of all the content that might be relevant. Discourse structuring may involve determining the order and level of detail in which content is expressed. Referring expression generation may involve generating expressions that refer to entities previously mentioned in a dialogue. Lexicalization may involve deciding what words and phrases to use to express a concept. Linguistic realization may involve determining what linguistic structures, such as grammatical constructions, to use to express an idea. Explanation generation may involve generating a humanly-understandable, transparent explanation of a conclusion, chain of reasoning, or result of a machine learning model. End-to-end models may involve using machine learning to perform entire natural language processing tasks. Generative models may involve using machine learning to fully generate responses. Deep learning may involve using deep-neural-network-based machine learning to generate responses.

Similarly, the automated planning engine 114 and natural language generation engine 116 may operate to perform a problem-solving cycle, in conjunction with information retrieval engine 118. The Automated Planning Engine 114 is a component that may draw upon known automated planning techniques to generate solutions to customer problems, as described, for example in (Ghallab, Malik; Nau, Dana S.; Traverso, Paolo. 2004. Automated Planning: Theory and Practice, Morgan Kaufmann, San Francisco, Calif.). Automated Planning may consist of generating courses of action for achieving goals. Approaches to AI Planning include generating new plans from scratch and adapting preexisting plans to new planning problems.

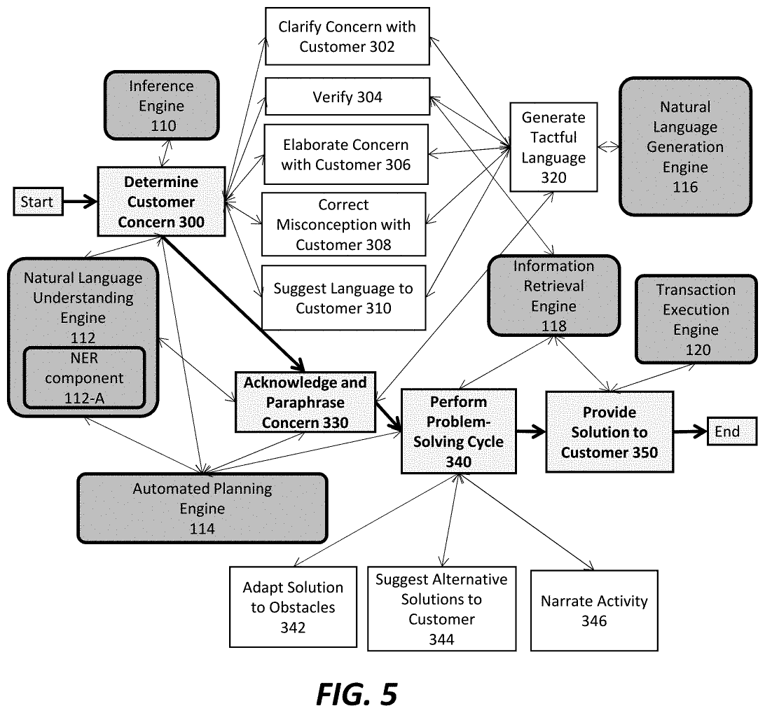

In accordance with embodiments of the disclosure, the automated planning engine comes into play once the system determines that sufficient information has been obtained (acquired in the previous stages) about the customer's concern(s) to attempt to come up with one or more solutions to address it/them. For example, a plan-based solution to troubleshooting an espresso machine that will not start may include a sequence of actions: check that the espresso machine is plugged in, check that the green light is on, etc. In different implementations, plans may be executable by the customer (the agent generates a plan and presents it to the customer, e.g., the espresso machine example), by the agent (the agent generates a solution plan that it will execute itself), or by the agent and customer in collaboration (the agent generates the plan but the agent and customer must collaborate to execute it). In particular embodiments the Automated Planning Engine 114 may conduct activities such as those detailed below with respect to FIG. 5.

To complete a customer interaction, the information retrieval engine 118 and transaction execution engine 120 may operate to provide a solution to the customer based upon the customer concern.

FIG. 5 illustrates further details of the scenario of FIG. 4, for implementing attentive dialogue. In this scenario, the block 300 may invoke other blocks, including block 302, block 304, block 306, block 308, and block 310, consistent with embodiments of the disclosure, where customer input is received by the attentive dialogue agent 108. As an example, one operation for determining customer concern may involve clarifying the customer concern (block 302). A given utterance or series of utterances by a customer may be analyzed to identify anything the attentive dialogue agent 108 has reason to doubt the truth of. This identification may require clarification when the attentive dialogue agent 108 believes differently from the customer statement, or has no belief with respect to a stated fact, and may require further information. In one example, the attentive dialogue agent 108 may believe based upon customer input that the customer wants “A” with a likelihood of 0.9, or wants “B” with a likelihood of 0.8, resulting in a query to the customer to clarify as between A and B.

In particular embodiments, the customer's concern, as expressed in their utterance, may be clarified as follows. Assuming intent recognition was used by the Natural Language Understanding Engine 112 and the confidence level for matching the customer's utterance to an intent (and, possibly, its arguments) is low, clarification may consist of asking the customer to confirm the standard phrasing of the intent. For example, the vague utterance “I like new coffeemaker plz!” may be recognized as the intent “Purchase espresso machine” with a confidence level below a specified threshold. Clarification may consist of asking the customer to confirm their intent through a follow-up question using wording more closely matching the intent, such as “You'd like to purchase an espresso machine. Is that correct?”

Determining the customer concern may involve a verify operation, block 304, to verify various issues, circumstances, or series of facts, to flesh out the customer concern, beyond what is received in an initial customer query or statement. Any customer utterance may include assertions that are verifiable by the system. The system will attempt to identify verifiable assertions and to verify them. Such assertions can be about facts or rules (e.g., company policies regarding customer loyalty programs). Here's an example of a customer utterance containing two verifiable assertions, the former about facts, the latter about rules: “I'm a GoldRewards member so I should get free one-day shipping for a year!” In this example, one assertion is a Verifiable assertion about facts: “I'm a GoldRewards member”. Another assertion is a Verifiable assertion about rules: “Customers with the GoldRewards membership status receive free one-day shipping for a year.” Fact verification may consist of retrieving entity values that are stored in various components such as databases, and comparing the stored entity values against stated entity values mentioned by the customer. For example, if the customer states “I've paid $600 for this [espresso machine name] and now I see that it's available online from [vendor name] for only $400!”, verification can consist of checking the customer's transaction history to confirm that they did purchase the mentioned espresso machine for $600. Notably, in some embodiments, the block 304 may make use of Information Retrieval Engine 118 to support the verification operation.

At various instances after receiving customer input, the attentive dialogue agent 108 may elaborate the concern, block 306, as additional facts are received from the customer or from information sources 122, of system 100.

During the operation of determining customer concern at block 300, the natural language generation engine 116 may generate tactful language, block 320. For example, during any of the blocks 302, 304, 306, 308, or 310, for both clarity and social reasons, the attentive dialogue agent 108 may adjust the language sent to the customer across agent interface 106, as well as adjusting “social behavior” to mirror the customer's, where appropriate. Thus, the dialogue received from the customer or dialogue sent by the attentive dialogue agent 108 to the customer may start off rather formally. Subsequently, the attentive dialogue agent 108, via natural language generation engine 116, may intentionally follow the customer's lead in adopting conversational behavior that is more casual, while still professional. As another example, and referring to FIG. 3, the generation of tactful language may include adopting the pronouns used by the customer when referring to his/her cat (for example, “Say hello to her for me” in A13).

According to the operation of block 308, the attentive dialogue agent 108 may correct any misconceptions with the customer. Corrections may be employed even when referring to information not directly pertaining to the purported reasons for a customer call, as reflected in the conversation flow of the attentive dialogue 200. Moreover, the attentive dialogue agent 108 may employ tact to determine when to establish corrections or ignore the need to flag the corrections to the customer. It may be the case that certain corrections are important to establish (such as the price of a product), while other issues should be tactfully ignored (such as when the customer misspells the agent's name). In utterance C6, the agent detects a misconception on the part of the customer. By reference to information sources 122, the attentive dialogue agent may know that the espresso maker the customer currently has is pump-powered. Tactfulness assessment may therefore be employed to decide whether to correct a misconception and how to phrase the correction. For example, the natural language generation engine 116 may determine that the phrase “The PRS2 is pump-powered, not steam-powered” is not a tactful manner to correct a misconception to the customer, and instead may opt for “I wanted to make you aware of something, though. Regarding the PRS2, the machine you currently have, it's actually pump-powered.”

Notably, the abstract content of a response may be determined by one or more engines (e.g., see block 308 above). The Natural Language Generation Engine 116 generates the response discourse (its actual wording). Tactfulness may be manifested both at the response content level (what to say/not to say—see block 308 above) and at the discourse level (how to say it).

Notably, in various embodiments, once the system identifies possible misconceptions in the “Verify” block, block 304, the system will need to decide whether or not to correct each of the identified misconceptions. An example of a correction statement is: “According to my records, you only spent $390 on the [espresso machine name] you purchased from us.”

Notably, in particular embodiments, generating tactful language, as implemented in block 320, may be a major factor in making this decision as to whether to correct a given misconception. The decision may be made based on the tradeoff between misconception importance (such as an estimate of the severity of the potential negative consequences to the customer that may be caused by the persistence of the misconception) and tact considerations (such as minimizing the number of corrections per utterance/conversation so as not to unnecessarily embarrass or otherwise upset the customer).

Suggesting language to a customer, as in block 310, may entail helping the customer describe a problem when the customer is perceived as having trouble (as when the agent suggests the “superautomatic” term in A6). In this block, before making a correction, the attentive dialogue agent 108 may anticipate that the inability to articulate a request may embarrass the customer, and may decide beforehand to respond in a reassuring manner (A7) if the customer is floundering.

In some implementations, the suggesting language to a customer may be achieved through a rule-based approach, e.g., by checking for common misspellings of domain-specific terms.

In some implementations, the suggesting language to a customer may be achieved by using the output of a named entity recognition (NER) component 112-A of the Natural Language Understanding Engine 112. Thus, in one embodiment, whenever the confidence level of the NER component is less than 100%, the system may suggest to the customer the entity name that was fuzzily recognized by the NER. For example:
Customer: “I'd like to sign up for an Ultimatum account!”

Agent: “Do you mean an Ultimate account?”

In additional implementations, a lexical goal hierarchy may also be used as part of block 310.

As in the block for determining a customer concern, at block 330, the acknowledging and paraphrasing of the customer concern may be performed by implementing tactful language, using natural language generation engine 116.

As further shown in FIG. 5, the block 340 may be parsed into a series of sub-operations, shown as block 342, block 344, block 346, consistent with embodiments of the disclosure, where customer input is received by the attentive dialogue agent 108. As noted, the Automated Planning engine 114 may implement the sub-operations of block 340, such as in the following manner.

Adapt Solution to Obstacles (block 342): In this block, the Automated Planning Engine 114 may use plan repair techniques, including known plan repair techniques or related techniques to adapt a solution to unexpected circumstances, as described, for example, at (M. Fox, A. Gerevini, D. Long, I. Serina. 2006. Plan stability: Replanning versus Plan Repair. International Conference on Automated Planning and Scheduling (ICAPS), pp. 212-221, AAAI Press, Cumbria, UK). Plan repair is described by the authors of the cited paper as “adapting an existing plan to a new context whilst perturbing the original plan as little as possible.” Situations in which plan repair is applicable include those in which the expected context does not match the real context at plan execution time.

As an example: the agent provides the customer a plan which includes the action “push the green button on your espresso machine”. The customer reports that the green button is stuck, so the agent uses plan repair or a similar technique to generate a new plan that takes into account this unexpected state (e.g., the new plan involves actions meant to get the green button unstuck, or avoids the green button altogether).

Suggest Alternative Solutions to Customer (block 344): In this block, according to some embodiments, the Automated Planning Engine 114 may select from a variety of known plan generation techniques to generate a set of multiple possible solutions for addressing the customer's concern(s) (see, e.g., Coman, A., and Muñoz-Avila, H. 2011. Generating Diverse Plans Using Quantitative and Qualitative Plan Distance Metrics. In Proceedings of the Twenty-Fifth AAAI Conference on Artificial Intelligence, 946-951, AAAI Press, San Francisco, Calif.). Diverse plan generation may consist of generating a set of distinct plans that solve the same problem. Approaches to diverse plan generation include modifying the heuristic function of an AI planning systems to include measures of diversity.

Narrate Activity (block 346): In this block the Automated Planning Engine 114 may keep track of planning traces documenting the planning process(es) that the Automated Planning Engine 114 undertook during a conversation with a customer. The Automated Planning Engine 114 may use these traces to generate a narrative documenting the attempts undertaken by the Automated Planning Engine 114 to solve the customer's problem, thus providing a form of transparent cognition. As such, the Automated Planning Engine 114 will need to collaborate with the Natural Language Generation engine 116 to generate the narrative to the customer. An example of such a narrative could be: “I'm currently trying to come up with a few possible solutions for you” [The Automated Planning engine 114 is using a diverse planning approach to generate a set of diverse plans], “The solution I had in mind for you looks like it might not work due to a temporary impediment. Let me see if I can find a workaround.” [The Automated Planning engine 114 is conducting plan repair after having observed an unexpected state.]

At block 342 the automated planning engine 114 may adapt a solution to obstacles, such as obstacles identified during the determination of the customer concern. At block 344, the automated planning engine 114, in conjunction with the information retrieval engine 118, may suggest (an) alternative solution(s) to the customer. Thus, in the example of attentive dialogue 200, when the customer indicates uncertainty about purchasing the PRS200 espresso machine after realizing the PRS200 cannot automatically steam milk, the agent suggests a further search to determine what products might be available (A9-A10) that automatically make cappuccino from start to finish.

At block 346, the automated planning engine 114 and information retrieval engine 118 may also provide a narrative of the activity at various stages during the problem-solving cycle of block 340. In some instances, the narrative may include the “showing the work” of the attentive dialogue agent 108. That is, the attentive dialogue agent 108 reveals some knowledge and cognitive processes (in addition to the final solution to the customer's problem) when the attentive dialogue agent 108 determines that doing so creates a harmonious and successful interaction with the customer. For example, the attentive dialogue agent 108 may describe the multiple options being considered or just the fact that multiple options are being considered (A13). In the attentive dialogue 200 (utterance A3—“No, indeed, that's a new one for me.”), although the attentive dialogue agent 108 doesn't usually reveal information about conversations with other customers, the attentive dialogue agent 108 reasons that this very general and inconsequential comment about prior experiences can safely be made.

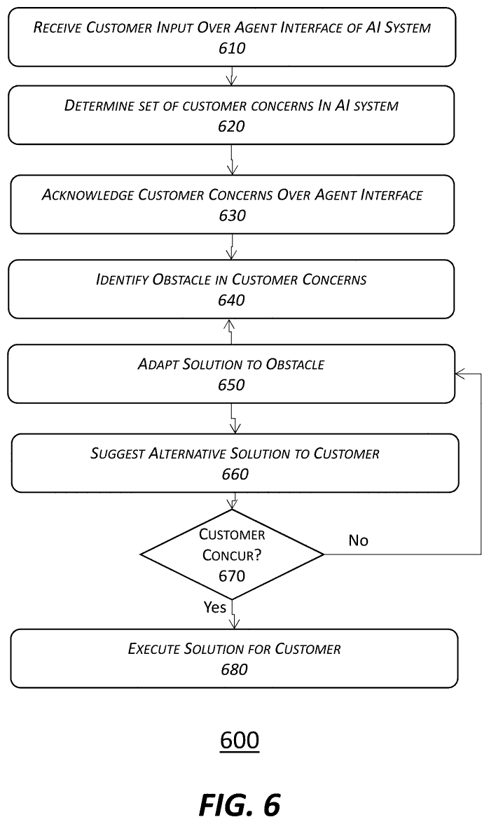

FIG. 6 illustrates an embodiment of a logic flow 600. The logic flow 600 may be representative of some or all the operations executed by one or more embodiments described herein. Embodiments are not limited in this context.

At block 610 customer input is received over an agent interface of an artificial intelligence (AI) system. The AI system may include an attentive dialogue agent to engage a customer in a natural language dialogue session. According to various embodiments, the agent interface may be a voice interface and/or a chatbot interface. The agent interface may further convert received speech to text (e.g., based on a known language processing algorithm (not separately shown)) to facilitate the ability of the system 100 to engage in attentive dialogue.

At block 620, a set of customer concerns is determined by the AI system, based upon the customer input. The speech or text received at the agent interface may be converted into machine-readable form for processing by an attentive dialogue agent of the AI system, where the attentive dialogue agent engages with the user via the agent interface to determine the customer concern.

At block 630, the set of customer concerns is acknowledged to the customer via the agent interface. The acknowledgement of the customer concern(s) may include a restatement of a problem or query provided by the customer in the customer input. The acknowledgement may use tactful language to restate a problem or request given by the customer.

At block 640, an obstacle to be addressed is identified from the set of customer concerns. At block 650, the AI system may adapt a solution to the identified obstacle. At block 660, an alternative solution may be suggested to the user by the AI system to address or overcome the obstacle. At decision block 670, if the customer concurs with the suggested solution, the flow proceeds to block 680, where the AI system executes the solution for the customer. If not, the flow returns to block 650.

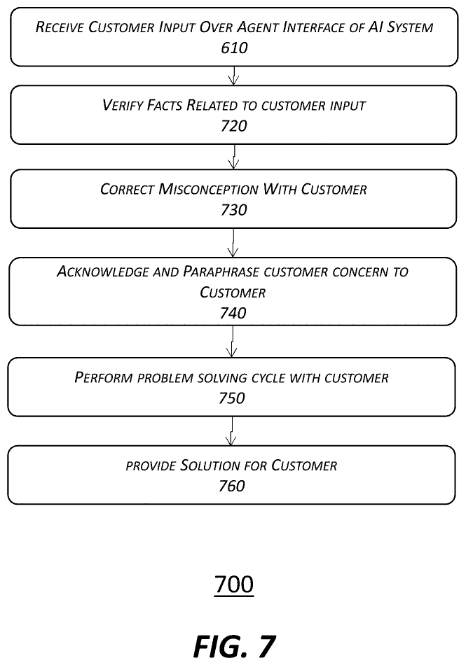

FIG. 7 illustrates an embodiment of a logic flow 700. The logic flow 700 may be representative of some or all of the operations executed by one or more embodiments described herein. Embodiments are not limited in this context.

The flow starts at block 610, described previously. At block 720, the AI system verifies facts related to the customer input. At block 730, the AI system may send a set of clarifying statements and/or questions to correct misconceptions that are perceived based upon the received customer input. At block 740, after the correcting of misconceptions, the AI system may acknowledge and paraphrase a customer concern to the customer, based upon the initial customer input, and after the verification of facts and correction of misconceptions. At block 750, the AI system may then engage in a problem-solving cycle with the customer, based upon the customer concern. At block 760, a solution is delivered to the customer by the AI system, based upon the results of the problem-solving cycle.

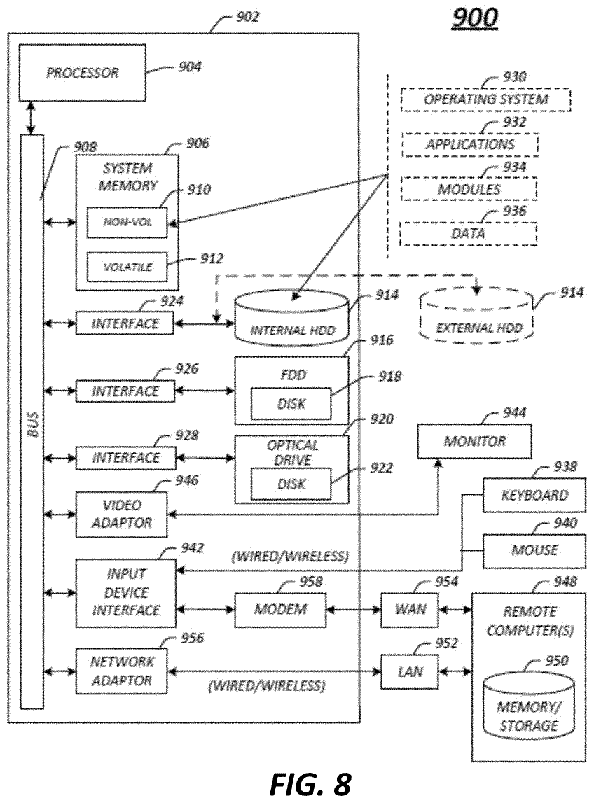

FIG. 8 illustrates an embodiment of an exemplary computing architecture 900 comprising a computing system 902 that may be suitable for implementing various embodiments as previously described. In various embodiments, the computing architecture 900 may comprise or be implemented as part of an electronic device. In some embodiments, the computing architecture 900 may be representative, for example, of a system that implements one or more components of the system 100. In some embodiments, computing system 902 may be representative, for example, of the attentive dialogue agent 108, and information sources 122 of the system 100. The embodiments are not limited in this context. More generally, the computing architecture 900 is configured to implement all logic, applications, systems, methods, apparatuses, and functionality described herein with reference to FIGS. 1-7.

As used in this application, the terms “system” and “component” and “module” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing system 902 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing system 902.

As shown in FIG. 8, the computing system 902 comprises a processor 904, a system memory 906 and a system bus 908. The processor 904 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi processor architectures may also be employed as the processor 904.

The system bus 908 provides an interface for system components including, but not limited to, the system memory 906 to the processor 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 906 can include non-volatile memory 910 and/or volatile memory 912. A basic input/output system (BIOS) can be stored in the non-volatile memory 910.

The computing system 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies. The computing system 902 is generally configured to implement all logic, systems, methods, apparatuses, and functionality described herein with reference to FIGS. 1-7.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the system 100, e.g., the inference engine 110, natural language understanding engine 112, automated planning engine 114, natural language generation engine 116, information retrieval engine 118, and transaction execution engine 120.

A user can enter commands and information into the computing system 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computing system 902. In addition to the monitor 944, a computer typically includes other peripheral output devices, such as speakers, printers, and so forth.

The computing system 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computing system 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computing system 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computing system 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computing system 902, or portions thereof, can be stored in the remote memory/storage device 950. It will be appreciated that the network connections shown are exemplary and other means of establishing a communications link between the computers can be used.

The computing system 902 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A non-transitory computer-readable storage medium storing computer-readable program code executable by a processor to:
determine a set of customer concerns by a set of AI engines executing on the processor, the set of customer concerns based upon customer input from a customer, the customer input being received by one of: an interactive voice response system, a phone system, a short message service system, an email message, and a data network;
generate an acknowledgment of the set of customer concerns, by the AI engines executing on the processor; and
perform a problem-solving cycle, by the set of AI engines executing on the processor, based upon the set of customer concerns, the problem-solving cycle comprising:
adapting a solution to an obstacle identified in the set of customer concerns;
suggesting an alternative solution to the customer; and
narrating a set of actions taken during the problem-solving cycle.

2. The non-transitory computer-readable storage medium of claim 1, wherein the set of AI engines are to determine the set of customer concerns by at least one of:
clarifying an initial concern with the customer;
verifying facts associated with the customer input;
elaborating the initial concern with the customer;
correcting a misconception with the customer; and
suggesting language to the customer.

3. The non-transitory computer-readable storage medium of claim 1, further comprising computer-readable program code executable to:
receive the customer input by a natural language understanding (NLU) engine executing on the processor; and
translate the customer input into a machine-readable form for execution by the set of AI engines.

4. The non-transitory computer-readable storage medium of claim 3, wherein the customer input comprises incoming dialogue, the NLU engine to determine meaning of the incoming dialogue by utilizing one or more of: intent classification, named entity recognition (NER), sentiment analysis, relation extraction, semantic role labeling, question analysis, rule extraction and discovery, and story understanding.

5. The non-transitory computer-readable storage medium of claim 4, further comprising computer-readable program code executable to:
determine the set of customer concerns, using a natural language understanding (NLU) engine executing on the processor in conjunction with at least one additional AI engine of the set of AI engines, including a natural language generation (NLG) engine, where the NLG engine is arranged to generate tactful language, responsive to the customer input.

6. The non-transitory computer-readable storage medium of claim 1, further comprising computer-readable program code executable to:
perform the problem-solving cycle by an information retrieval (IR) engine, executing on the processor in conjunction with the set of AI engines.

7. The non-transitory computer-readable storage medium of claim 6, further comprising computer-readable program code executable to:
provide a customer solution based upon the problem-solving cycle, by a transaction execution engine, executing on the processor in conjunction with the IR engine.

8. A method, comprising:
determining, by a set of AI engines executing on a processor, a set of customer concerns based upon customer input, received from a customer, the customer input being received by one of: an interactive voice response system, a phone system, a short message service system, an email message, and a data network;
acknowledging, by the set of AI engines executing on the processor, the set of customer concerns; and
performing, by the set of AI engines executing on the processor, a problem-solving cycle, based upon the set of customer concerns, the performing the problem-solving cycle comprising:
adapting a solution to an obstacle identified in the set of customer concerns;
suggesting an alternative solution to the customer; and
narrating a set of actions taken during the problem-solving cycle.

9. The method of claim 8, wherein determining the set of customer concerns comprises at least one of:
clarifying an initial concern with the customer;
verifying facts associated with the customer input;
elaborating the initial concern with the customer;
correcting a misconception with the customer; and
suggesting language to the customer.

10. The method of claim 9, wherein the verifying facts comprises:
retrieving, using an information retrieval engine (IR engine), stored entity values from a database; and
comparing the stored entity values with stated entity values, received in the customer input.

11. The method of claim 8, further comprising:
receiving, by a natural language understanding (NLU) engine executing on the processor, the customer input; and
translating the customer input into a machine-readable form for execution by the set of AI engines.

12. The method of claim 8, wherein the set of customer concerns is determined by a natural language understanding (NLU) engine executing on the processor in conjunction with a natural language generation (NLG) engine, wherein the NLG engine is arranged to generate tactful language, responsive to the customer input.

13. The method of claim 12, wherein the customer input comprises incoming dialogue, wherein the NLU engine is executable on the processor to determine meaning of the incoming dialogue by utilizing one or more of: intent classification, named entity recognition (NER), sentiment analysis, relation extraction, semantic role labeling, question analysis, rule extraction and discovery, and story understanding.

14. The method of claim 8, further comprising providing a customer solution based upon the problem-solving cycle, by a transaction execution engine, executing on the processor in conjunction with an information retrieval (IR) engine.

15. A system, comprising:
a processor;
an interface, to receive customer input, coupled to the processor and comprising one of: an interactive voice response system, a phone system, a short message service system, an email message system; and a data network; and
a memory storing instructions executable by the processor to:
determine a set of customer concerns by a set of AI engines, the set of customer concerns based upon customer input from a customer, received over the interface;
generate an acknowledgment by the set of AI engines, of the set of customer concerns; and
perform a problem-solving cycle by the set of AI engines, based upon the set of customer concerns, the problem-solving cycle comprising:
adapting a solution to an obstacle identified in the set of customer concerns;
suggesting an alternative solution to the customer; and
narrating a set of actions taken during the problem-solving cycle.

16. The system of claim 15, the memory storing instructions executable by the processor to determine the set of customer concerns by at least one of:
clarifying an initial concern with the customer;
verifying facts associated with the customer input;
elaborating the initial concern with the customer;
correcting a misconception with the customer; and
suggesting language to the customer.

17. The system of claim 15, the memory storing instructions executable by the processor to:
receive the customer input by a natural language understanding (NLU); and
translate the customer input into a machine-readable form for execution by the set of AI engines.

18. The system of claim 15, the memory storing instructions executable by the processor to:
retrieve, using an information retrieval engine (IR engine), a set of stored entity values from a database; and
compare the set of stored entity values with stated entity values, received in the customer input.

19. The system of claim 15, the memory storing instructions executable by the processor to:
determine the set of customer concerns by a natural language understanding (NLU) engine, in conjunction with a natural language generation (NLG) engine, where the NLG engine is executable to generate tactful language, responsive to the customer input.

20. The system of claim 15, the memory storing instructions executable by the processor to:
provide a customer solution based upon the problem-solving cycle, by a transaction execution engine, operating in conjunction with an information retrieval engine.
